(19) United States
(12) Patent Application Publication
(10) Pub. No.: US 2005/0056800 A1
(43) Pub. Date: Mar. 17, 2005

(54) Automotive emission control valve having impact noise attenuation feature for the armature

(76) Inventor: Russell Miles Modien, Chatham (CA)

Correspondence Address: Elsa Keller;Siemens Corporation, Intellectual Property Department, 170 Wood Avenue, Iselin, NJ, 08830, US

(21) Appl. No.: 10/919,818

(22) Filed: Aug. 17, 2004

Related U.S. Application Data
(60) Provisional application No. 60/497,718, filed on Aug. 20, 2003.

(51) Int. Cl. F16K 31/00; F16K 31/02

(52) U.S. Cl. 251/64; 251/129.15

(57) ABSTRACT

An emission control valve (10) for controlling flow of gases with respect to combustion chamber space of an internal combustion engine. The valve has a housing (12) providing a flow path between an inlet port (14) for receiving gases and an outlet port (16) for delivering gases to the combustion chamber space. An armature (40) forms a valve element that selectively seats on and unseats from a seat (32) to selectively close and open the flow path. A permanent magnet source (40) magnetically biases the armature toward the seat. A solenoid (18) unseats the armature from the seat. A stop (64, 84, 104, 124) limits travel of the armature away from the seat. An energy absorbing structure (50, 70, 90, 110) mounted on the armature is arranged to strike the stop and absorb kinetic energy from the armature as the armature approaches the stop.

### REFERENCE TO A RELATED APPLICATION AND PRIORITY CLAIM

This application claims the benefit of U.S.

Provisional Application No. 60/497,718, filed 20 Aug. 2003.

### FIELD OF THE INVENTION

This invention relates to solenoid-operated control valves, especially emission control valves, such as purge valves, for automotive vehicles.

### BACKGROUND OF THE INVENTION

A known on-board evaporative emission control system in an automotive vehicle powered by a gasoline engine includes a fuel vapor collection canister that collects volatile fuel vapors from the headspace of the fuel tank and a canister purge solenoid (CPS) valve that is opened at appropriate times to purge fuel vapors collected in the canister to the engine intake system where they entrain with the fuel-air charge entering the engine for combustion. A known CPS valve comprises a solenoid actuator that is under the control of a microprocessor-based engine management system to control the opening and closing of the valve.

Certain such CPS valves comprise a movable valve element that is resiliently biased against a valve seat by a mechanical spring to close flow through the valve. When electric current flows through the solenoid actuator, a resulting electromagnetic field applies force to the solenoid armature in opposition to the spring bias force to unseat the valve element and allow flow through the valve. When the electric current ceases, the electromagnetic field collapses so that its force is no longer applied to the armature, allowing the spring bias force to re-seat the valve element closed and hence disallow flow through the valve.

A novel CPS valve is disclosed in commonly owned U.S. patent application Ser. No. ______ filed ______. Instead of having a spring that imparts resilient bias to the movable valve element, the armature is permanently magnetized and arranged so as to be magnetically attracted to a stop that comprises magnetically permeable material and that defines one limit of travel for the movable valve element. When the current flows through the solenoid actuator, electromagnetic force acts with sufficient intensity on the permanently magnetized armature to oppose the magnetic attraction of the armature to the stop and move the armature away from the stop. The armature motion unseats the valve element, allowing flow through the valve.

Movement of the armature away from the stop is limited by abutment of the armature with an opposite stop. When electric current flow through the solenoid actuator is discontinued, the electromagnetic field collapses, allowing the magnetic force of attraction of the armature to the first stop to move the armature back against that stop, thereby re-seating the valve element closed so as to disallow flow through the valve.

The armature itself may or may not form the movable valve element. When the armature forms the movable valve element, the stop toward which it is magnetically attracted forms the valve seat. An example of such an armature is a cylindrical disc that moves within a suitable guide between the opposed stops.

One advantage of this novel CPS valve is that it does not require a mechanical spring to bias the valve element closed. Consequently when the armature is unseated to open the valve, the armature motion is not resisted by a bias spring. And because the electromagnetic force must be large enough to overcome not only the permanent magnet bias but also any stiction between the armature and seat, the armature is apt to strike the stop that limits its travel away from the seat while containing a significant amount of kinetic energy.

Certain patents disclose various forms of impact absorbing structures in solenoid-actuated valves, such as CPS valves. Examples appear in U.S. Pat. Nos. 4,901,974; 5,538,219; 5,775,670; 5,967,487; and 6,595,485. All of those examples utilize a bias spring that biases the valve element closed, and so some of the kinetic energy of the moving armature and opening valve element will be absorbed by compression of the bias spring rather than by an energy absorbing structure on the armature.

### SUMMARY OF THE INVENTION

Accordingly, a general aspect of the invention relates to an emission control valve for controlling flow of gases with respect to combustion chamber space of an internal combustion engine. The valve has a housing providing a flow path between an inlet port for receiving gases and an outlet port for delivering gases to the combustion chamber space. An armature forms a valve element that selectively seats on and unseats from a seat to selectively close and open the flow path. A permanent magnet source magnetically biases the armature toward the seat. A solenoid unseats the armature from the seat. A stop limits travel of the armature away from the seat. An energy absorbing structure mounted on the armature is arranged to strike the stop and absorb kinetic energy from the armature as the armature approaches the stop.

Another general aspect relates to a fluid valve comprising a housing having an inlet port for receiving fluid and an outlet port for delivering fluid. A solenoid is disposed within the housing. A flow path extends within the housing between the inlet port and the outlet port and passes through the solenoid. An armature is controlled by the solenoid for operation between a position seated on the solenoid to close the flow path to fluid flow and a position unseated from the solenoid to open the flow path for fluid flow. A stop is disposed to stop the armature as the armature operates toward the unseated position. An elastomeric element is disposed on the armature and comprises both an energy absorbing formation for impact with the stop to dissipate kinetic energy of the armature as the armature approaches the stop and a seal for sealing the armature to the solenoid when the armature is in the seated position.

A more specific aspect is that the permanent magnet source is in the armature.

Another more specific aspect is that the permanent magnet source is the sole bias source acting on the armature.

Another more specific aspect is that an end of a stator of the solenoid forms the seat.

More specific aspects relate to details of various embodiments of energy absorbing structures.

Still more aspects will be seen in the accompanying drawings and described in the detailed description given herein.

### BRIEF DESCRIPTION OF THE DRAWINGS

The accompanying drawings, which are incorporated herein and constitute part of this specification, illustrate presently preferred embodiments of the invention according to the best mode contemplated at this time, and, together with the detailed description given here, serve to disclose the various aspects and features of the invention.

FIG. 1 is a longitudinal cross-section view of an exemplary CPS valve incorporating principles of the invention in a first embodiment.

FIG. 2 is an enlarged fragmentary view of a portion of FIG. 1.

FIG. 3 is an enlarged fragmentary view of a portion of FIG. 2.

FIG. 4 is a view similar to FIG. 3 showing a second embodiment.

FIG. 5 is a view similar to FIG. 3 showing a third embodiment.

FIG. 6 is a view similar to FIG. 3 showing a fourth embodiment.

### DETAILED DESCRIPTION

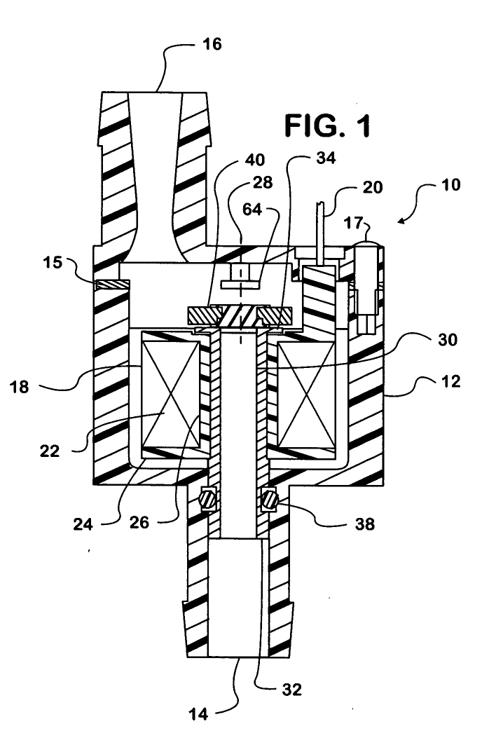

FIGS. 1-3 show a CPS valve 10 that comprises a housing 12 having an inlet port 14 adapted to be communicated to a vapor collection canister in an automotive evaporative emission control system and an outlet port 16 adapted to be communicated to the intake system of a gasoline engine that powers the automotive vehicle.

Housing 12 comprises housing parts fastened together by screws 17 with an intervening gasket 15 to enclose a solenoid 18 whose electric terminals 20 protrude through housing 12 to provide for a bobbin-mounted coil 22 of the solenoid to be electrically connected to the vehicle electrical system so as to place valve 10 under the control of an engine management system.

The bobbin, designated by the reference numeral 24, comprises a cylindrical tubular core 26 coaxial with an imaginary longitudinal axis 28 of the valve. Core 26 fits coaxially to a cylindrical tubular body 30 of a ferromagnetic stator 32 that comprises a circular flange, or lip, 34 at one end. At the same end, bobbin 24 has a shallow circular recess 36 in which flange 34 sits. The depth of recess 36 is less than the flange thickness so that the end surface of the flange is slightly beyond the end face of the bobbin.

The end of stator 32 opposite flange 34 protrudes from the opposite end of bobbin core 26 to fit into the tubular wall of port 14, with an O-ring 38 sealing between the outer perimeter of the core and the inner perimeter of the port wall. Vapor that enters port 14 is thereby constrained to pass through body 30 of stator 32 as it flows through the valve toward outlet port 16.

A circular disc armature 40 is disposed within housing 12 coaxial with axis 28 for cooperation with the end of stator 32 containing flange 34. FIG. 1 shows armature 40 seated on that end of the stator.

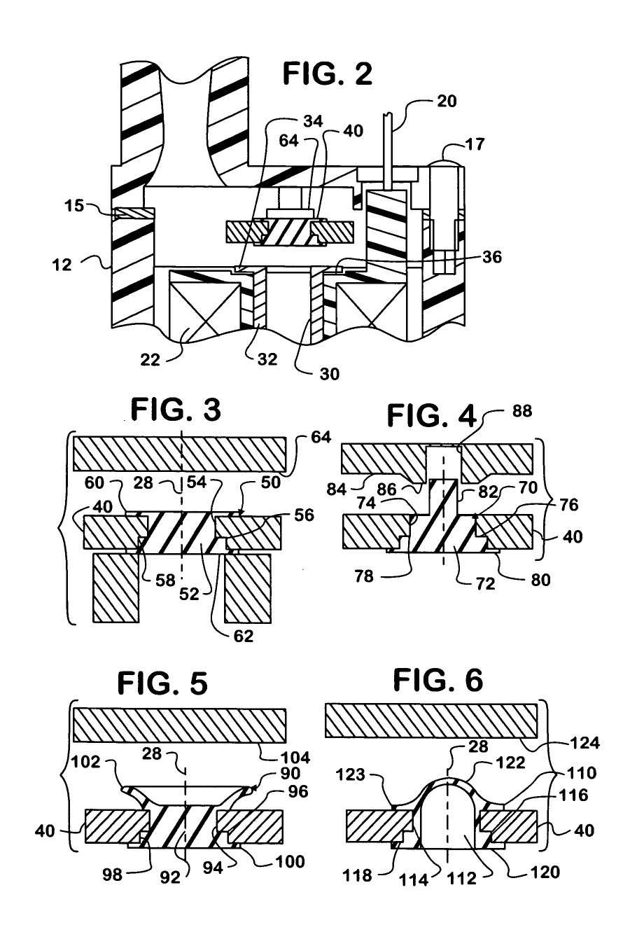

When so seated, armature 40 closes the flow path through the valve to disallow flow between ports 14 and 16. FIG. 2 shows armature 40 unseated from the end of the stator containing flange 34, a condition that opens the flow path through the valve to allow flow between ports 14 and 16.

Armature 40 comprises permanently magnetized material, an example of which is Neodymium (NdFeB). Because stator 32 comprises ferromagnetic material such as low carbon steel (UNS 1008), armature 40 is attracted toward the end containing flange 34. The magnetic force of attraction is sufficiently large to seat armature 40 as shown in FIG. 1.

Travel of armature 40 between closed and open positions depicted respectively by FIGS. 1 and 2 is guided by a suitable guide within housing 12 that functions to maintain armature 40 substantially coaxial with axis 28 without hindering vapor flow while the armature is unseated.

Unseating of armature 40 occurs when coil 22 is electrically energized. Coil 22 is designed to impart to armature 40 an electromagnetic force that is opposite to the force of magnetic attraction of armature 40 toward stator 32 and that is large enough to assure that the armature will unseat when coil 22 is energized. Because the magnitude of that electromagnetic force must not only accelerate the armature from zero velocity, but also break the seal (hereinafter explained) of the armature to the seat, the armature, once unseated, will have a certain inertia that must be dissipated upon stopping. If the armature is allowed to directly impact a solid stop, such as a wall of housing 12 or an adjustable stop member 64, that is adjustable axially on the housing wall, objectionable noise may be generated upon such impact. Moreover, repeated impacting may create wear on the impacting parts due to the magnitude of impact force.

In accordance with principles of the invention, energy absorbing structure is associated with armature 40 to attenuate impact force and noise that accompanies such impact. That structure can include a seal for vapor-tight sealing of the armature to the stator when the armature is seated closed on the stator.

The embodiment of FIGS. 1-3, shows an energy absorbing element 50 associated with armature 40. Element 50 comprises a body 52 of elastomeric material that mounts in a central through-hole 54 of complementary shape in armature 40. Both body 52 and through-hole 54 comprise complementary shoulders 56, 58. At each end, element 50 comprises a respective circular formation 60, 62 of uniform thickness that joins with body 52 and radially overlaps the respective armature end face around through-hole 54.

Formation 62 serves to seal armature 40 vapor-tight to the end of the solenoid when the armature is seated to disallow flow. It can also absorb impact as the armature re-seats after having been operated to open position. Formation 60 serves to absorb impact of armature 40 with stop member 64 when the armature is unseated. Stop 64 can be made adjustable along the direction of axis 28 to set the amount of armature travel.

FIGS. 4, 5, and 6 shows additional embodiments that may offer even better impact absorption because of their particular shapes.

FIG. 4 shows an energy absorbing element 70 associated with armature 40. Like element 50, element 70 comprises a body 72 of elastomeric material that mounts in a central through-hole 74 of complementary shape in armature 40. Both body 72 and through-hole 74 also comprise complementary shoulders 76, 78, and at the end confronting the solenoid, element 70 comprises a circular formation 80 of uniform thickness that joins with body 72 to radially overlap the armature end face around through-hole 74 for sealing armature 40 vapor-tight to the end of the solenoid when the armature is seated to disallow flow. Like formation 60, formation 80 can also absorb impact as the armature re-seats.

At its opposite end, element 70 comprises a circular cylindrical post 82 projecting from body 72 substantially coaxial with axis 28. A stop 84 is arranged for cooperation with that end of element 70 to limit armature travel away from the seat. Stop 84 differs from stop 64 in that the former comprises an annular boss 86 surrounding a blind circular hole 88. Boss 86 and hole 88 are substantially concentric with axis 28, with boss 86 confronting the annular portion of body 72 surrounding post 82 and with hole 88 being open toward the post.

Upon armature 40 unseating to allow flow through the valve, post 82 travels ever deeper into hole 88. This may serve to impart some pneumatic damping to the armature motion. If the post 82 is sufficiently long to strike the bottom of hole 88 before body 72 strikes boss 86, the post will absorb some of the energy of impact. If not, energy will be absorbed by the impact of body 72 with boss 86, and if the armature has not been fully decelerated before post 82 strikes the bottom of hole 88, then the post may begin to share in absorbing energy to bring the armature to a complete stop. The distal end of post 82 may have a parabolic or cup-like shape for achieving a desired energy absorption rate.

FIG. 5 shows an energy absorbing element 90 associated with armature 40. Like elements 50 and 70, element 90 comprises a body 92 of elastomeric material that mounts in a central through-hole 94 of complementary shape in armature 40. Both body 92 and through-hole 94 also comprise complementary shoulders 96, 98, and at the end confronting the solenoid, element 90 comprises a circular formation 100 of uniform thickness that joins with body 92 to radially overlap the armature end face around through-hole 94 for sealing armature 40 vapor-tight to the end of the solenoid when the armature is seated to disallow flow.

At its opposite end, element 90 comprises a saucer-shaped formation 102 supported on body 92, substantially coaxial with axis 28. A stop 104 is arranged for cooperation with formation 102 for stopping armature travel away from the stator. Stop 104 has a flat face confronting the concave face of formation 102.

Upon armature 40 unseating to allow flow through the valve, the rim of formation 102 will strike the confronting flat face of stop 104. Continued motion of the armature will flex formation 102, with the flexing absorbing the impact and eventually stopping the armature. Although formation 102 may appear to have a shape like a suction cup, its rim is relieved so that it will not be forced to stick to stop 104.

FIG. 6 shows an elastomeric energy absorbing element 110 associated with armature 40. Element 110 comprises a body 112 that mounts in a central through-hole 114 of complementary shape in armature 40. Unlike prior embodiments however, body 112 is hollow rather than solid. The particular shape of body 112 is shown as tubular. Both body 112 and through-hole 114 also comprise complementary shoulders 116, 118, making the wall of tubular body 112 thicker along a portion of its length that is toward the stator. At its end confronting the stator, element 110 comprises a circular annular formation 120 of uniform thickness that joins with the thicker-walled portion of body 112 to radially overlap the armature end face around through-hole 114 for sealing armature 40 vapor-tight to the end of the stator when the armature is seated closed to disallow flow.

At its opposite end, element 110 comprises a dome-shaped formation 122 projecting from body 112, substantially coaxial with axis 28. The interior of formation 122 is hollow. At its base that joins with the thinner-walled portion of body 112, formation 122 has an annular outer flange 123 that is disposed against the margin of the armature through-hole. A stop 124 is arranged for cooperation with formation 122 for stopping armature travel away from the seat. Stop 124 has a flat face confronting formation 122.

Upon armature 40 unseating to allow flow through the valve, the rounded peak of formation 122 will strike the confronting flat face of stop 124. Continued motion of the armature will begin to flatten the peak, reducing the height of the dome-shaped formation, and as the peak flattens, the formation absorbs the impact and eventually stops the armature. The shape and thickness of the dome may be designed to achieve a desired energy absorption rate.

When the solenoid of any of the CPS valves that have been described is energized, the valve will open due to the overpowering electromagnetic force that acts on the armature to unseat the armature from the seat that is provided by the end of the stator. The respective element 50, 70, 90, 110 will strike the respective stop 64, 84, 104, 124 to arrest the armature motion during the impact, attenuating the impact force and resulting noise in the process. As long as the coil remains energized by electric current, the valve stays open. When the electric current stops, the electromagnetic force applied by the solenoid actuator to the armature essentially ceases, allowing the permanent magnetism of the armature to pull the armature back to re-seat it on the end of the stator thereby closing the flow path through the valve.

While the foregoing has described a preferred embodiment of the present invention, it is to be appreciated that the inventive principles may be practiced in any form that falls within the scope of the following claims.

1. An emission control valve for controlling flow of gases with respect to combustion chamber space of an internal combustion engine comprising:
a housing providing a flow path between an inlet port for receiving gases and an outlet port for delivering gases to the combustion chamber space;
an armature forming a valve element that selectively seats on and unseats from a seat to selectively close and open the flow path; and
a permanent magnet source magnetically biasing the armature toward the seat;
a solenoid for unseating the armature from the seat;
a stop for limiting travel of the armature away from the seat; and
an energy absorbing structure mounted on the armature and arranged to strike the stop and absorb kinetic energy from the armature as the armature approaches the stop.

2. An emission control valve as set forth in claim 1 wherein the permanent magnet source is in the armature.

3. An emission control valve as set forth in claim 1 wherein the permanent magnet source is the sole source of bias acting to bias the armature toward the seat.

4. An emission control valve as set forth in claim 1 wherein the solenoid comprises a stator that forms a portion of the flow path, and one end of the stator forms the seat.

5. An emission control valve as set forth in claim 1 wherein the armature comprises a disc having opposite faces, and the energy absorbing structure comprises an elastomeric element that comprises a body fit to a central through-hole in the armature between the opposite faces, a first formation that joins with the body at one of the faces, and a second formation that joins with the body at the other of the faces.

6. An emission control valve as set forth in claim 5 wherein the body is solid and the first formation comprises a substantially uniform thickness including an annular flange that overlaps the margin of the through-hole at the one face.

7. An emission control valve as set forth in claim 6 wherein the second formation comprises a substantially uniform thickness including an annular flange that overlaps the margin of the through-hole at the other face.

8. An emission control valve as set forth in claim 5 wherein the body is solid, the first formation comprises a central post projecting axially away from the body, and the stop comprises a blind hole into which the post extends ever deeper as the armature moves toward the stop.

9. An emission control valve as set forth in claim 8 wherein the stop comprises a boss surrounding the blind hole, and the boss is disposed to be struck by an annular surface of the body surrounding the post as the armature moves toward the stop.

10. An emission control valve as set forth in claim 5 wherein the body is solid, and the first formation comprises a wall that is concave toward the stop and has a rim that engages the stop as the armature approaches the stop.

11. An emission control valve as set forth in claim 5 wherein the body is hollow , the first formation comprises a hollow dome having a peak that that engages the stop as the armature approaches the stop.

12. A fluid valve comprising:
a housing having an inlet port for receiving fluid and an outlet port for delivering fluid;
a solenoid disposed within the housing;
a flow path that extends within the housing between the inlet port and the outlet port and that passes through the solenoid;
an armature controlled by the solenoid for operation between a position seated on the solenoid to close the flow path to fluid flow and a position unseated from the solenoid to open the flow path for fluid flow;
a stop disposed to stop the armature as the armature operates toward the unseated position; and
an elastomeric element that is disposed on the armature and comprises an energy absorbing formation for impact with the stop to dissipate kinetic energy of the armature as the armature approaches the stop and that also comprises a seal for sealing the armature to the solenoid when the armature is in the seated position.

13. A fluid valve as set forth in claim 12 wherein the solenoid comprises a stator tube forming a portion of the flow path through the solenoid, and the seal of the elastomeric element seats on an axial end of the stator tube when the armature is in seated position.

14. A fluid valve as set forth in claim 12 wherein the armature comprises a permanent magnet having a through-hole in which the elastomeric element is mounted.

15. A fluid valve as set forth in claim 12 wherein the armature comprises opposite faces, and the elastomeric element comprises a body fit to a central through-hole in the armature between the opposite faces, the energy absorbing formation joins with the body at one of the faces, and the seal joins with the body at the other of the faces.

16. A fluid valve as set forth in claim 15 wherein the body is solid and the energy absorbing formation comprises a substantially uniform thickness including an annular flange that overlaps the margin of the through-hole at the one face.

17. A fluid valve as set forth in claim 16 wherein the seal comprises a substantially uniform thickness including an annular flange that overlaps the margin of the through-hole at the other face.

18. A fluid valve as set forth in claim 15 wherein the body is solid, the energy absorbing formation comprises a central post projecting axially away from the body, and the stop comprises a blind hole into which the post extends ever deeper as the armature moves toward the stop.

19. A fluid valve as set forth in claim 18 wherein the stop comprises a boss surrounding the blind hole, and the boss is disposed to be struck by an annular surface of the body surrounding the post as the armature moves toward the stop.

20. A fluid valve as set forth in claim 15 wherein the body is solid, and the energy absorbing formation comprises a wall that is concave toward the stop and has a rim that engages the stop as the armature approaches the stop.

21. A fluid valve as set forth in claim 15 wherein the body is hollow, the energy absorbing formation comprises a hollow dome having a peak that that engages the stop as the armature approaches the stop.
